(19) United States
(12) Patent Application Publication
(10) Pub. No.: US 2006/0255940 A1
(43) Pub. Date: Nov. 16, 2006

(54) System and method for electronic device recycle tracking

(76) Inventors: Robert White, Pflugerville, TX (US); Kara Thompson, Austin, TX (US)

Correspondence Address: HAMILTON & TERRILE, LLP, P.O. BOX 203518, AUSTIN, TX, 78720, US

(21) Appl. No.: 11/125,451

(22) Filed: May 10, 2005

(51) Int. Cl. G08B 13/14

(52) U.S. Cl. 340/572.1

(57) ABSTRACT

Recovery of electronic devices is tracked and attributed to the manufacturers of the electronic devices with RFID tags affixed to the electronic devices. For instance, an information handling system has a RFID tag integrated with its chassis at manufacture and is then shipped to a consumer. The RFID tag stores recovery information for use at recovery of the information handling system, such as the manufacturer, weight, recycle classification and a unique identification code. More detailed recovery information is optionally stored in a network-accessible recovery database by reference to information readable from the RFID tag. At its end-of-life of the electronic device is received at a recovery site and the recovery information is read by a RFID scanner. A recovery monitor applies the read recovery information to allocate recovery costs to the manufacturer and otherwise manage the recycling or disposal of the electronic device.

### BACKGROUND OF THE INVENTION

1. Field of the Invention

The present invention relates in general to the field of electronic device recycling, and more particularly to a system and method information handling system recycle tracking with identification tags.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are built from a plurality of electronic components having a variety of materials. The constant improvement in the capabilities of information handling systems are tied, in part, to the development of more efficient and powerful components having greater complexity in design and materials used. Naturally, as more powerful information handling systems become available businesses and individuals tend to discard older used systems in favor of newer and more powerful replacement systems. However, the discarding of used information handling systems has begun to create environmental concerns. For instance, the materials used to build information handling system components sometimes include heavy metals and other potentially hazardous materials. Information handling system displays, printers and other peripherals also sometimes include such hazardous materials. To avoid the release of potentially-toxic materials into the environment, governments and information handling system manufacturers have cooperated to encourage recycling of used systems. Recycling collection centers breakdown information handling systems to recover and reuse hazardous materials that might otherwise end up in a landfill.

One recent recycling initiative in Europe, the European Waste Electronic and Electrical Equipment (WEEE) directive, scheduled to take effect in August of 2005 seeks to enforce recycling of a wide variety of electronic devices, including appliances, communication equipment, entertainment equipment, lighting, electronic toys, tools, leisure and sports equipment, medical devices, control equipment, automatic dispensers and information handling systems. The WEEE directive encourages and regulates the collection, reuse, recycling and recovery of electrical and electronic equipment by making the manufacturer of electronic equipment finance end-of-life recycling and recovery costs as well as meet recycling targets within a limited time after the regulations are enforced. One suggested implementation of the WEEE directive is a national clearing house (NCH) funded by participating manufacturers. As a result, manufacturers of electric equipment used in Europe are discussing ways to track equipment by type and manufacturer in as efficient a manner as possible in order to determine funding for the NCH.

### SUMMARY OF THE INVENTION

Therefore a need has arisen for a system and method which automates tracking of electronic equipment for recycling.

In accordance with the present invention, a system and method are provided which substantially reduce the disadvantages and problems associated with previous methods and systems for tracking electronic equipment for recycling. A RFID tags are integrated in electronic devices at manufacture, each RFID tag having recovery information associated with its electronic device. At the end of life of the electronic device, the recovery information is read from the RFID tag to manage recovery of the electronic device, such as allocating recovery costs or managing recycling.

More specifically, plural electronic device manufacturers integrate RFID tags in electronic devices to help manage recovery of the electronic devices at their end of life. For instance, an information handling system integrates a RFID tag which provides recovery information related to the information handling system, such as the manufacturer of the system, the recycling classification of the system, the weight of the system and an unique identifier for the system. Peripherals included with the information handling system also integrate RFID tags with similar information, such as for monitors, printers and keyboards. The recovery information is stored in an electronic device RFID database that is accessible by recovery sites and the information handling system is sent to an end user or consumer site. At its end of life, the information handling system and/or its peripherals are received at a recovery site where the recovery information is read by a RFID scanner. A recovery monitor reads the recovery information, supplements the read information from the electronic device RFID database as needed, and manages recovery of the system with a recycle site or disposal site. The recovery monitor tracks recovered information from the recovered electronic devices to allocate recovery costs to electronic device manufacturers, such as by weight, recycle classification or other desired parameters.

The present invention provides a number of important technical advantages. One example of an important technical advantage is that recovery information associated with recovered information handling systems is gathered and tracked with minimal cost and minimal interference with electronic device operation. The RFID tags are read from a distance without physical or visual contact with an electronic device so that scanning of RFID tags is compatible with automated processing of recovered electronic devices. The RFID tags do not emit energy until activated by a RFID scanner and thus do not introduce electromagnetic interference to the operation of the electronic device. However, adequate information may be inexpensively stored on the RFID tags to support management of recovery operations with minimal expense.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for allocating electronic device recovery costs with RFID tags; and

FIG. 2 depicts a flow diagram of a process for allocating electronic device recovery costs with RFID tags.

### DETAILED DESCRIPTION

Electronic devices, such as information handling systems, have an RFID tag incorporated at manufacture to in order to track the manufacture source at recovery of used systems, such as for allocating recycling costs. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

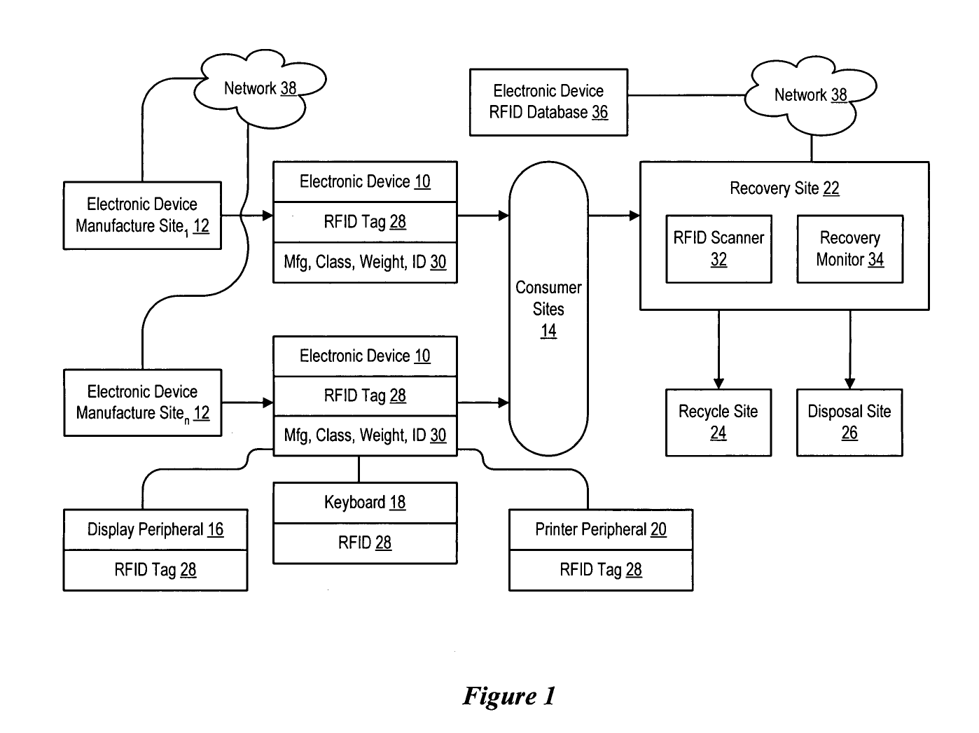

Referring now to FIG. 1, block diagram depicts a system for allocating electronic device recovery costs with RFID tags. Electronic devices 10 are made at electronic device manufacture sites 12 for use at consumer sites 14. For instance, electronic devices 12 are information handling systems that are shipped with a variety of peripheral electronic devices, such as a display peripheral 16, a keyboard peripheral 18 and a printer peripheral 20. The electronic devices are manufactured by a plurality of manufacturers who share financial responsibility for recovery of electronic devices from consumer sites 14 at a recovery site 22, such as for recycling at a recycling site 24 or safe disposal at a disposal site 26. In order to allocate responsibility for the recovery of electronic devices 10 at recovery site 22, each manufacturer of electronic devices includes an RFID tag 28 having recovery information 30. The RFID tags 28 are incorporated in the electronic devices and sit idle unless scanned by a predetermined radio frequency. Upon receiving the predetermined radio frequency energy, RFID tag 28 emits radio frequency energy that outputs the recovery information. Such RFID tags are, for instance, used to identify pets by insertion of the tags into the pet's body for reading if the pet becomes lost.

Recovery information included in RFID tags 28 includes information that directly supports recovery operations or information that allows a look up of further information for support of recovery operations. For instance, the recovery information includes the manufacturer, the weight and the recycle class of the electronic device. When the electronic device arrives at recovery site 22, an RFID scanner 32 reads the weight and recycle class information and a recovery monitor 34 uses the read information to allocate financial responsibility to the manufacturer by weight and to determine appropriate recycling actions. As another example, the recovery information includes a unique identifier, such as an identification code that is unique to each electronic device or each model of electronic device. At manufacture of the electronic device, the manufacturer populates an electronic device RFID database 36 with the unique identification code. At recovery of the electronic device at recovery site 22, recovery monitor 34 looks up the unique identification code through a network 38, such as the Internet, to obtain additional recovery information, such as details of the materials used to build the electronic device and/or sales data from the manufacturer or manufacturers. Recovery site 22 is thus able to more effectively handle each type of electronic device providing, for instance, different recovery procedures for information handling systems and their various peripherals such as displays, keyboards and printers. Further, detailed calculations as to recovery costs are maintained by recovery monitor 34 to help ensure appropriate allocation to manufacturers, such as by weight and type of recovered material.

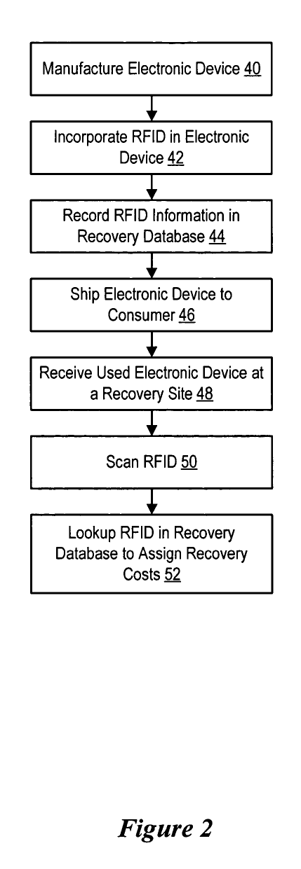

Referring now to FIG. 2, a flow diagram depicts a process for allocating electronic device recovery costs with RFID tags. The process begins at step 40 with the manufacture of an electronic device, such as an information handling system or associated peripherals. At step 42, a RFID tag is incorporated into the electronic device, such as in the interior of an information handling system chassis, the RFID tag having recovery information for use at recovery of system. At step 44, the recovery information of the RFID tag is recorded in a recovery database to associate the electronic device with the recovery information stored on the RFID tag. At step 46, the electronic device is shipped to a consumer for commercial use. Once the electronic device reaches its end of life, at step 48, the consumer sends the used electronic device to a recovery site for recycling or appropriate disposal. At step 50, the RFID tag is scanned at the recovery site to read the recovery information. Scanning of the RFID tag may be done in an automated fashion since the RFID scanner need not have physical or visual contact with the electronic device. At step 52, the RFID information is looked up in the recovery database to assign recovery costs to the manufacture of the electronic device. For example, each manufacturer is separately billed based on the weight and type of electronic devices received at the recovery site that were made by that manufacturer.

Although the present invention has been described in detail, it should be understood that various changes, substitutions and alterations can be made hereto without departing from the spirit and scope of the invention as defined by the appended claims.

What is claimed is:

1. A system for tracking recovery of used electronic devices, the system comprising:
plural electronic devices made by plural manufacturers;
an RFID tag coupled to each electronic device, each RFID tag having recovery information including at least the manufacturer of the device;
a recovery site associated with the recovery of used electronic devices made by plural manufacturers;
an RFID scanner associated with the recovery site and operable to read the RFID tags; and
a recovery monitor interfaced with the RFID scanner and operable to track the electronic devices recovered at the recovery site by manufacturer.

2. The system of claim 1 wherein the RFID tag further has weight information, the recovery monitor further operable to track the electronic devices by weight.

3. The system of claim 1 wherein the RFID tag further has recycling class information, the recovery monitor further operable to sort the recovered electronic devices by recycling class.

4. The system of claim 1 wherein the RFID tag further has a unique identification code, the recovery monitor further operable to retrieve recovery information from the manufacturer of the electronic device by reference to the unique identification code.

5. The system of claim 4 further comprising a recovery database interfaced with the recovery monitor through the Internet, the recovery database storing a list electronic devices associated with unique identification codes.

6. The system of claim 5 wherein the unique identification code identifies the model and manufacturer of the electronic device.

7. The system of claim 5 wherein the unique identification code is unique to each electronic device.

8. The system of claim 1 wherein the electronic device comprises an information handling system.

9. The system of claim 1 wherein the electronic device comprises an information handling system peripheral.

10. The system of claim 9 wherein the peripheral comprises a display.

11. A method for tracking recovery of used electronic devices made by plural manufacturers, the method comprising:
coupling an RFID tag to each electronic device at manufacture of the electronic device, the RFID tag having recovery information sufficient to at least identify the manufacturer of the electronic device;
shipping the electronic devices to consumers for use;
recovering the electronic devices at a recovery site after consumer use, the recovered electronic devices manufactured by plural manufacturers;
scanning the RFID tag at the recovery site to retrieve the recovery information; and
applying the recovery information to assign recovery responsibility to the manufacturers of the electronic devices.

12. The method of claim 11 wherein the recovery information comprises a weight associated with the electronic device and wherein applying the recovery information further comprises assigning recovery responsibility between manufacturer by the weight to recovered devices.

13. The method of claim 11 wherein the recovery information comprises a recycle class, the method further comprising:
sorting the recovered electronic devices by recycle class; and
recycling the recovered electronic devices.

14. The method of claim 11 wherein the recovery information comprises unique identification information, the method further comprising:
communicating the unique identification from the recovery site to the manufacturer of each recovered electronic device; and
sending recovery information associated with the unique identification information from the manufacturer of the electronic device to the recovery site.

15. The method of claim 15 wherein the unique identification information identifies the model of the electronic device.

16. The method of claim 11 wherein the electronic device comprises an information handling system.

17. The method of claim 11 wherein the electronic device comprises an information handling system peripheral.

18. The method of claim 17 wherein the information handling system peripheral comprises a display.

19. The method of claim 17 wherein the information handling system peripheral comprises a printer.

20. The method of claim 17 wherein the information handling system peripheral comprises a keyboard.
